(19) United States
(12) Patent Application Publication
(10) Pub. No.: US 2024/0269600 A1
(43) Pub. Date: Aug. 15, 2024

(54) FLEXIBLE AIR FILTER ELEMENT

(71) Applicant: MANN+HUMMEL LIFE SCIENCES & ENVIRONMENT HOLDING SINGAPORE PTE. LTD., Singapore (SG)

(72) Inventors: Pia OTT, Schwarzenbach (DE); Sandy ROSSBACH, Wirsberg (DE); Christian WEIGERT, Bindlach (DE)

(21) Appl. No.: 18/439,915

(22) Filed: Feb. 13, 2024

(30) Foreign Application Priority Data
Feb. 13, 2023 (EP) 23156201.8

(51) Int. Cl. B01D 46/52; B01D 46/00; B01D 46/30

(52) U.S. Cl. CPC B01D 46/522; B01D 46/0005; B01D 46/30; B01D 2265/04; B01D 2275/10

(57) ABSTRACT

The invention refers to a deformable filter element comprising a flexible side element to seal pleats of its filter medium. An end section of the side element is bent over fold edges. The end section and the fold edges are secured to one another. The end section and a main section of the side element, which main section is typically arranged perpendicular to the fold edges, are neither parallel nor perpendicular to each other.

### TECHNICAL FIELD

The present invention refers to a filter element comprising a pleated filter medium and at least a first flexible side element, which seals pleats of the filter medium at first side face, wherein at least a first end section of the first side element protrudes above first fold edges of the filter medium.

### BACKGROUND

Such a filter element is known form EP 1 391 233 A1.

Filters for the filtration of an airflow are known in a large number of different design variants. Since the efficiency of filters depends in particular on the size of the filter surface through which the air flows, pleated filter media, i.e. filter media pleated in a zigzag shape, are used for many applications. Depending on the pleat height and the pleat spacing of the pleated filter pack, the effective surface area of the filter medium can be increased.

Depending on the shape and size of installation space available, it may be required that a filter element with its pleated filter pack be fixed in a bent condition in the associated filter housing. Likewise, it may be required to bend the filter element for insertion into the filter housing. In the filter housing, the pleated filter pack can then be used in a flat shape or in a bent shape.

It was found that protruding parts of sidebands, which abut a housing, are often subject to high stress during mounting or removal of the filter element. On the one hand, this is due to the forces exerted by the operator to push the filter element into the housing or to remove the filter element from the housing. On the other hand, the pretension of the filter element resulting from its bent shape presses the sideband against the housing. Consequently, a bonding of the sideband to the pleated filter pack can be damaged in particular by repeated installation of the filter element.

A flexible filter element comprising a pleated filter medium which is sealed at both sides by compressible sidebands is known from DE 195 28 670 A1. A similar flexible filter element is disclosed in EP 1 275 428 A1.

EP 1 391 233 A1, mentioned above, describes a filter insert with a substantially plate-shaped filter element, which is provided on at least two opposite side faces with a sealing flap, the height of which is greater than the plate thickness, wherein the projecting part of the sealing flap forms a sealing lip which, in a filter housing accommodating the filter insert, can be applied under elastic prestress to the housing wall in a sealing manner for sealing the filter insert with respect to the housing. The sealing flap projects beyond the filter element on both sides and forms sealing lips on both the upper and lower sides of the plate-like filter element. This allows the filter insert to be mounted in the housing in either orientation of the upper and lower sides.

A filter element having a filter medium is known from EP 1 431 090 A2. The filter element is laterally bounded on at least one side by an edge strip oriented perpendicular to the filter plane defined by the filter medium. A sealing strip is part of the edge strip. It projects beyond the filter plane and is delimited from the rest of the edge strip by a predetermined bending line, which may be formed as an incision facing away from the filter medium. Stiffening of the bending line is provided by a thickened glue bead opposite to the incision.

A filter element with a fold pack having sides is known from US 2009/0044503 A1. A lateral strip at least partially surrounds the sides of the fold pack. The lateral strip is made of thermally deformable lateral strip material. At least one guide section projects laterally from the filter element and is made from the thermally deformable lateral strip material. The guide section and the lateral strip are monolithic with regard to the material wherein the guide section is formed by thermal deformation of the lateral strip. By means of the guide section, the filter element can be secured in a receptacle of a housing.

It is an object of the invention to provide an easy to install filter element with reliable sealing of its pleats.

This is achieved by a filter element according to claim 1 and an air filter according to claim 12. Advantageous embodiments are given in the subclaims and the description.

### DISCLOSURE OF THE INVENTION

In accordance with the invention, a filter element is provided. The filter element comprises a pleated filter medium and at least a first flexible side element, in particular a first flexible sideband, which seals pleats of the filter medium at a first side face. Thus, the first side element forces an airflow to pass through the filter medium, where particulates or the like are retained. The flexibility of the side element allows the filter element to be bent and/or twisted. This facilitates installation of the filter element with limited access to a housing. Further, the filter element can be used in a deformed, i.e. bent and/or twisted state. Generally, the filter element is not (additionally) deformed by the airflow passing through it during use.

Preferably, the first side element is made from a nonwoven fabric. Such kind of material allows the pleats to be fixed in place eg by use of an adhesive, and to seal up open edges of the pleats, while being flexible enough to allow for significant deformation of the filter element. Further, nonwoven fabric can adapt to the fold edges and allows for local deformation where the fold edges contact the nonwoven fabric.

The first side element may be glued to the filter medium. Adhesive is preferably applied to the first side element. Alternatively or additionally, adhesive may be applied to a side portion of the filter medium. The adhesive used for gluing of the side element to the filter medium can be a hotmelt adhesive.

At least a first end section of the first side element protrudes above first fold edges of the filter medium. The first end section can be used to seal the filter element against a housing.

The first fold edges define an upstream or downstream face of the filter element. Generally, second fold edges define a face opposite to the face defined by the first fold edges, i.e., a downstream or upstream face.

The first and second fold edges can also be referred to as pleat tips. It is understood that the fold edges may be formed as a sharp kink or as a rounded edge.

According to the invention, the first end section is angled towards the filter medium with respect to a main section of the first side element by an angle of at least 5° and at most 85° and the first end section is affixed to the first fold edges. An angle between an end section, here the first end section of the first side element, and the main section of 0° means that the end section is in the same plane as the main section. Preferably, the angle between the first end section and the main section is at least 22°, particularly preferably at least 35°. The angle between the first end section and the main section is preferably at most 67°, particularly preferably at most 55°.

In an undeformed state, the main section of the side element typically extends orthogonal to the fold edges. The angled first end section covers the first fold edges at the upstream or downstream face. Thereby, the first end section slightly overlaps the upstream or downstream face. Thus, it is assured, that the first side face is completely sealed. By fixing, in particular gluing the first angled end section to the first fold edges, a particularly strong connection of the first side element and the filter medium is obtained. Affixing the end section to the fold edges may further advantageously prevent the end section from bending in an unintended direction, thus allowing a reliable sealing of a raw side and a clean side of the air filter. The first angled end section provides an inclined surface, which facilitates mounting or dismounting of the filter element into or from a housing. Furthermore, by arranging the first end section to cover the first fold edges at the upstream or downstream face, the first end section covers an adhesive layer, which may be present between the first side element and the filter medium. Consequently, contact of the adhesive with the housing during installation or removal of the filter element is avoided. Thus, contamination of the housing by abrasion of the adhesive is prevented. Furthermore, the material of the first side element generally exhibits lower friction than the adhesive. Mounting and dismounting of the filter element is therefore further facilitated.

The first end section may at least be partly glued to the first fold edges. The glue or adhesive layer may be provided in any gaps between an end section and its corresponding fold edges, here the first end section and the first fold edges. The adhesive layer may be provided to fill any gaps between the end section and the fold edges. The adhesive layer may be provided in an amount sufficient for the adhesive not to escape the end section, or an end face of the side element as described below if present, thereby avoiding contact of the adhesive with the housing. An excessive amount of adhesive may cause the side element to lose its flexibility. The adhesive layer provided between the end section and its corresponding fold edges may be part of the adhesive used to adhere the side element to the filter medium.

A portion of the filter medium contacting the intersection of the main section and an end section of the first side element is defined as a first edge of the first or second fold edges. As the end section advances from the intersection to an end face of the side element, the distance between the end section and the fold edges increases due to the inclined surface of the angled end section. The glue or adhesive layer provided between the end face and the fold edges may have a thickness that is larger than the layer provided between the intersection and the first edge.

The filter medium may comprise two layers of filter media and filling material, in particular particulate filling material, arranged between the two layers. Each layer of filter media may in turn comprise a plurality of layers of filter media overlaid and stacked to form multilayer filter media. The filter medium may therefore comprise at least two layers of filter media and filling material, in particular particulate filling material, arranged between the layers. The filter media may be selected from filter paper, synthetic fiber, glass fiber, and combinations thereof. Preferably, the filling material comprises adsorbent material, such as activated carbon, ion exchange resin, and combinations thereof. The filling material can for instance remove odors or harmful gases from the airflow, in particular by adsorption to the filling material. With this kind of filter media, it is particularly crucial to ensure reliable and permanent sealing of the filter medium at its sides to prevent the filling material from leaking out, which is achieved by the angled end section affixed to the fold edges.

An end face of the first side element may extend approximately perpendicular, preferably at an angle of 90°+/−30°, particularly preferably at an angle of 90°+/−15°, with respect to the first end section. Consequently, the end face of the side element is generally inclined with respect to the fold edges of the filter medium. The inclined end face facilitates removal of the filter element, in particular if a housing has a protrusion, over which the side element must be moved. Furthermore, an outer edge, which is formed between the first end section and the end face, can be employed as a sealing lip for abutment against the housing.

A second end section of the first side element may protrude above second fold edges of the filter medium. The second end section may be angled towards the filter medium with respect to a main section of the first side element by an angle of at least 5° and at most 85°. Preferably, the angle between the second end section and the main section is at least 22°, particularly preferably at least 35°. The angle between the second end section and the main section is preferably at most 67°, particularly preferably at most 55°. The second end section is affixed to the second fold edges. Further features of the first end section, as described above, may be applied at the second end section as well. The second angled end section is particularly advantageous if the filter element shall contact, in particularly sealingly abut, a housing at the upstream and at the downstream face of the filter element.

The filter element may further comprising a second flexible side element, in particular a second flexible sideband, which seals pleats of the filter medium at a second side face, wherein at least a first end section of the second side element protrudes above the first fold edges of the filter medium, wherein the first end section of the second side element is angled towards the filter medium with respect to a main section of the side element by an angle of at least 5° and at most 85°, and wherein the first end section of the second side element is affixed to the first fold edges. Preferably, the angle between the first end section and the main section of the second side element is at least 22°, particularly preferably at least 35°. The angle between the first end section and the main section of the second side element is preferably at most 67°, particularly preferably at most 55°. The second side element may comprise further features as described above for the first side element. In particular, a second end section of the second side element may protrude above the second fold edges of the filter medium. The second end section may be angled towards the filter medium with respect to a main section of the second side element by an angle of at least 5° and at most 85°. Preferably, the angle between the second end section and the main section of the second side element is at least 22°, particularly preferably at least 35°. The angle between the second end section and the main section of the second side element is preferably at most 67°, particularly preferably at most 55°. The second end section of the second side element is affixed to the second fold edges. The first or second end sections of the second side element may be designed in the same way as the first or second end sections of the first side element.

Preferably, the filter element is plate-shaped in an undeformed state. In the undeformed state, the first and second fold edges may in particular define a flat upstream or a flat downstream face, respectively.

Alternatively, the filter medium may annularly surround a longitudinal axis. The filter element is thus ring shaped, in particular with a cylindrical upstream and downstream face. The annular filter medium may be stabilized by a support tube or the like, which restricts deformation of the filter element. During use, an airflow may pass through the filter medium in the radial direction with respect to the longitudinal axis. In this embodiment, the first flexible side element and the second flexible side element (if provided) are end caps. The advantages for installation, removal and sealing apply here as well.

The invention also refers to an air filter comprising a housing and a filter element as described above. The housing may define a flat or curved interior for reception of the filter element. Generally, an inlet and an outlet are provided at the housing.

The filter element may be installed in the housing in an undeformed state. In other words, the filter element is undeformed, when completely arranged inside the housing. In this embodiment, the flexibility of the filter element can be exploited in particular during installation of the filter element. In particular, the filter element can be deformed prior or during insertion into the housing. The angled end section(s) may contribute to facilitate installation and avoid contact of adhesive, which is applied between the side element and the filter medium, and the housing.

Alternatively, the filter element may be installed in the housing in a deformed state, in particular wherein the filter element is bent around an axis parallel to its fold edges and/or twisted around an axis perpendicular to its fold edges. In other words, the filter element is deformed, when arranged completely inside the housing. In this application, the flexible side element(s) with the angled end section(s) are particularly advantageous. The flexibility of the filter element allows the use thereof in a crooked housing for optimum exploitation of limited space. The sealing and guiding capacity of the angled end section(s) is particularly apparent in this application.

Preferably, an outer edge of the filter element, which is formed between the first end section and an end face of the first side element, sealingly abuts the housing. This allows for reliable sealing of a raw side and a clean side of the air filter. The fact, that the outer edge is formed between two surfaces, which are angled/inclined with respect to the fold edges, is particularly advantageous, if the filter element needs to be inserted beyond a protrusion of the housing. In this application, the oblique arrangement of surfaces adjacent to the outer edge reduces mounting/dismounting forces and leads to a significantly lower risk of tearing off the side element from the filter medium. The housing may comprise two housing parts, a joint of which protrudes towards the interior of the housing.

### BRIEF DESCRIPTION OF DRAWINGS

Other advantages and features of the invention will be appreciated from the following description of embodiments of the invention with reference to the figures of the drawing, which show significant details, and from the claims. The individual features, as described above or explained below, may each be implemented individually or implemented together in any useful combination in variants of the invention.

FIG. 1 shows a first embodiment of a filter element according to the invention, in a schematic perspective view;

FIG. 2 shows a schematic cross section of a pleated filter medium of the filter element of FIG. 1;

FIG. 3 shows a detail of the filter element of FIG. 1 in the area of a first sideband, in a schematic view;

FIG. 4 shows a second embodiment of a filter element according to the invention in a bent state, in a schematic perspective view;

FIG. 5 shows an air filter according to the invention comprising a housing and the filter element of FIG. 4, in a schematic perspective view;

FIG. 6 shows the air filter of FIG. 5 in a schematic sectional view;

FIG. 7 shows a detail of the air filter of FIG. 5 during installation, in a schematic sectional view;

FIG. 8 shows a detail of FIG. 6;

FIG. 9 shows a second air filter according to the invention, in a schematic perspective view;

FIG. 10 shows a detail of the air filter of FIG. 9 during installation of a filter element, in a schematic sectional view;

FIG. 11 shows a detail of FIG. 9, in a sectional view;

FIG. 12 shows a third air filter according to the invention, during installation of a filter element into a housing, in a schematic perspective view;

FIG. 13 shows a detail of sealing between a filter element and a housing of the air filter of FIG. 12, in a schematic sectional view;

FIG. 14 shows a fourth air filter according to the invention, during installation of a filter element into a housing, in a schematic perspective view;

### DETAILED DESCRIPTION

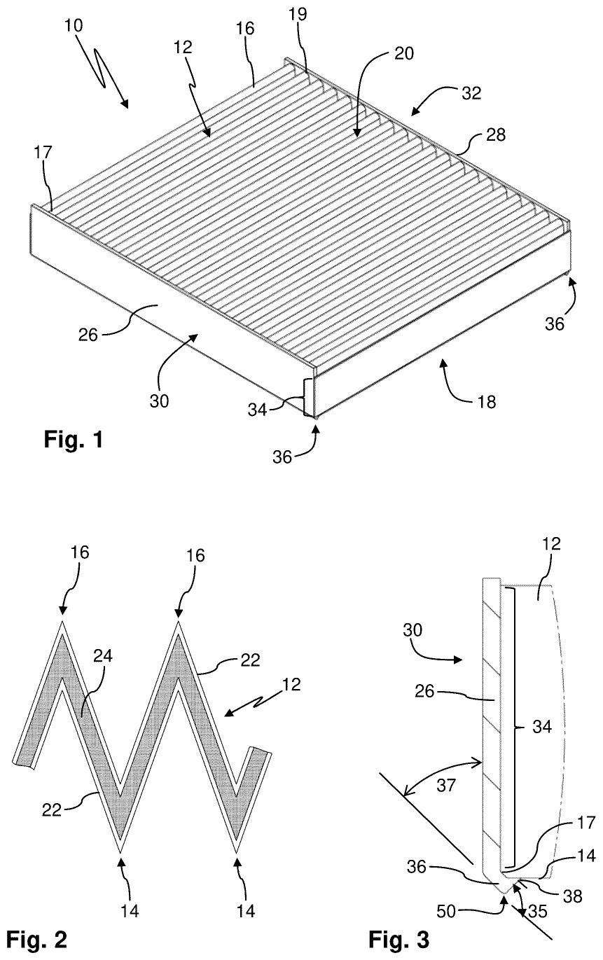

FIG. 1 shows a filter element 10. The filter element comprises a pleated filter medium 12. First and second fold edges (or pleat tips) 14, 16 define an upstream and downstream face 18, 20, respectively, see also FIG. 2. The fold edges 14, 16 run parallel to each other. In an undeformed state, which is depicted in FIG. 1, the filter element is plate-shaped; the upstream and downstream face 18, 20 are flat.

As can be seen from FIG. 2, the filter medium 12 comprises two layers of filter paper 22. A filling material 24, in this embodiment activated carbon particles, is enclosed between the layers of filter paper 22.

The filter element 10 comprises a first and a second side element 26, 28, here first and second sidebands, which seal the pleats of the filter medium 12 at a first and second side face 30, 32, respectively, see FIG. 1. A first edge 17 of the fold edges 14, 16 is at the first side face 30. The first edge 17 contacts the intersection of a main section 34 and a first end section 36 of the first side element 26. The first edge 17 also contacts the intersection of the main section 34 and a second end section 68 of the first side element 26 if present. A second edge 19 of the fold edges 14, 16 is at the second side face 32. The second edge 19 contacts the intersection of a main section 34 and a first end section 36 of the second side element 28. The second edge 19 also contacts the intersection of the main section 34 and a second end section 68 of the second side element 28 if present.

The side elements 26, 28 are made from flexible material, such as a nonwoven fabric. The side elements 26, 28 are adhered to the filter medium 12 by a hotmelt adhesive. Alternatively, the side elements 26, 28 may be made from a flexible thermoplastic material, such as rubber or hotmelt material, which may melt during production and adhere to the filter medium 12 when hardened.

A main section 34 of the side elements 26, 28 extends in a plane, which is perpendicular to the fold edges 14, 16, at least in the undeformed or flat state of the filter element 10. As is apparent in particular from FIG. 3, the side elements 26, 28 protrude beyond the first fold edges 14. In particular, the first side element 26 bends along the first edge 17, while the second side element 28 bends along the second edge 19. A first end section 36 of the first and second side elements 26, 28 is bent towards the filter medium 12. An angle 37 between outer surfaces of the main section 34 and the first end section 36 is preferably about 45°, for instance 45°+/−5°. In particular, the first end sections 36 cover the first fold edges 14 adjacent to the first or second side face 30, 32, respectively. The first end sections 36 are secured to the first fold edges 14, here by means of the hotmelt adhesive. It may be provided that the first fold edges 14 are impressed into the side elements 26, 28. Due to the inclined angle of the first end sections 36, the thickness of adhesive between the edges 17, 19 and the intersection of the main section 34 and first end section 36 is smaller than the thickness of adhesive between the fold edges 14, 16 and an end face 38 of the side element 26, 28.

At the first end section 36, the first and second side element 26, 28 each terminate in an end face 38. The end face 38 is oriented approximately perpendicular (for instance 90°+/−10°) to the outer surface of the first end section 36 (angle 35).

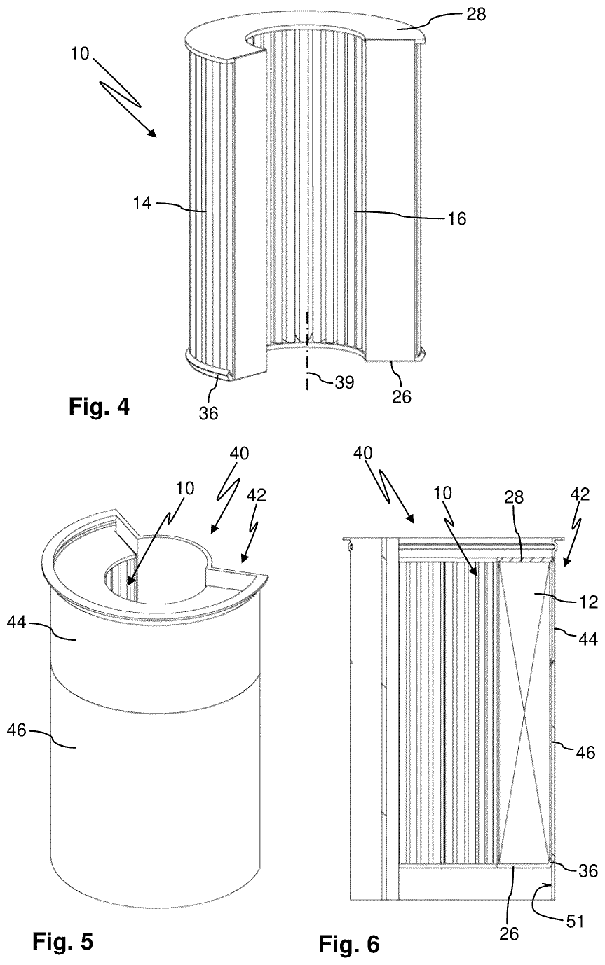

FIG. 4 shows a filter element 10 in a bent state. In particular, the filter element 10 is bent around an axis 39, which runs parallel to fold edges 14, 16.

The filter element 10 depicted in FIG. 4 differs from the filter element 10 shown in FIG. 1 in that only the first side element 26 has an angled end section 36; here, the second side element 28 is flat overall. In the bent configuration, the first end section 36 is on the radially outer side of filter element 10 with respect to bending axis 39.

In the bent shape, the filter element 10 may be inserted into a filter housing 42 to form an air filter 40, see FIGS. 5 and 6. A cover of housing 42 is not depicted. The first and second side elements 26, 28 sealingly abut the housing 42. An inlet and an outlet of the housing 42 for raw air and filtered air, respectively, are not depicted in FIGS. 5 and 6.

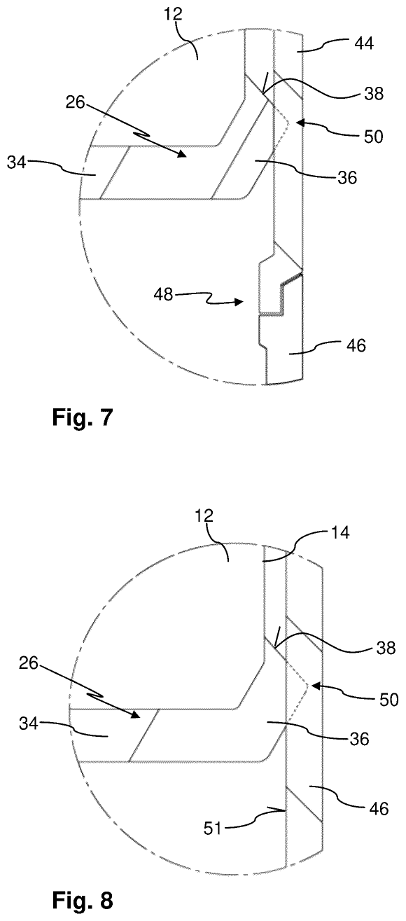

As can be appreciated in particular from FIG. 5 and FIG. 7, the housing 42 comprises two housing parts 44, 46. At a joint between the housing parts 44, 46 a protrusion 48 into the interior of the housing is formed. During installation of the filter element 10, the inclination of the first end section 36 facilitates pushing the first side element 26 past the protrusion 48. During removal of the filter element 10, the inclination of the end face 38 facilitates pulling the first side element 26 over the protrusion 48.

In the installed state, an outer edge 50, which delimits the outer surface of the first end section 36 from the end face 38, sealingly abuts an inner surface 51 of the housing 42, see in particular FIG. 8. In FIGS. 7 and 8, the outer edge 50 is shown in an undeformed configuration to overlap with the housing 40. Actually, the first side element 26 is compressed at the outer edge 50; the resulting contact pressure creates the desired sealing effect.

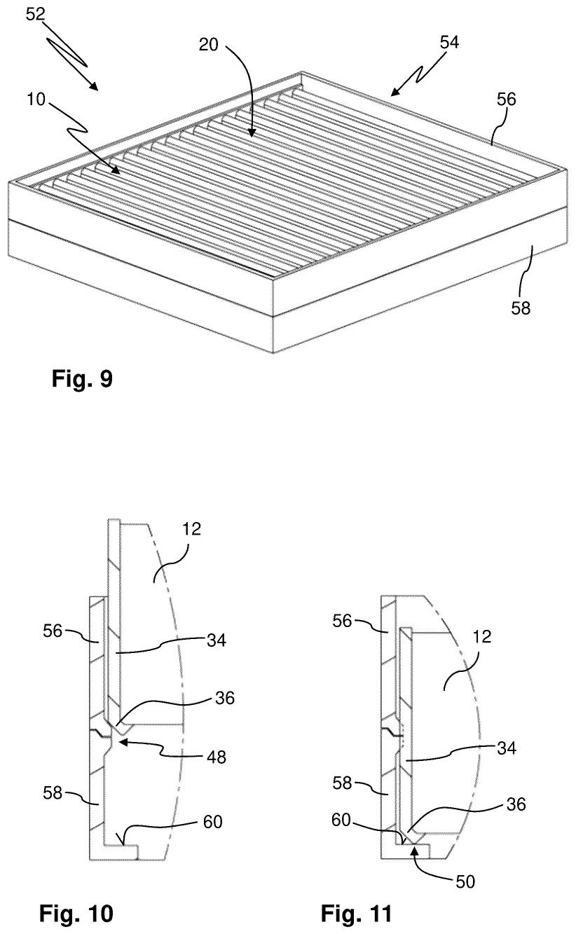

FIG. 9 shows an air filter 52 comprising a housing 54 and a filter element 10, as depicted in FIG. 1 and described above. The housing 54 comprises two housing parts 56, 58. At a joint between the housing parts 56, 58 a protrusion 48 into the interior of the housing is formed, see FIG. 10.

With the air filter 52, the filter element 10 is arranged inside the housing 54 in the undeformed, flat state.

For insertion into the housing 54, the filter element 10 may be bent and/or twisted. If enough space above housing 54 is available, the filter element 10 may be pushed into housing 54 in its undeformed, plate-like configuration. Then, the insertion direction is basically perpendicular to the upstream or downstream face 18, 20.

During installation of the filter element 10, the inclination of the first end section 36 facilitates pushing the first side element 26 past the protrusion 48. Since the filter element 10 is installed in its flat configuration, outer edge 50 sealingly abuts a flat sealing surface 60 of housing 54, see FIG. 11.

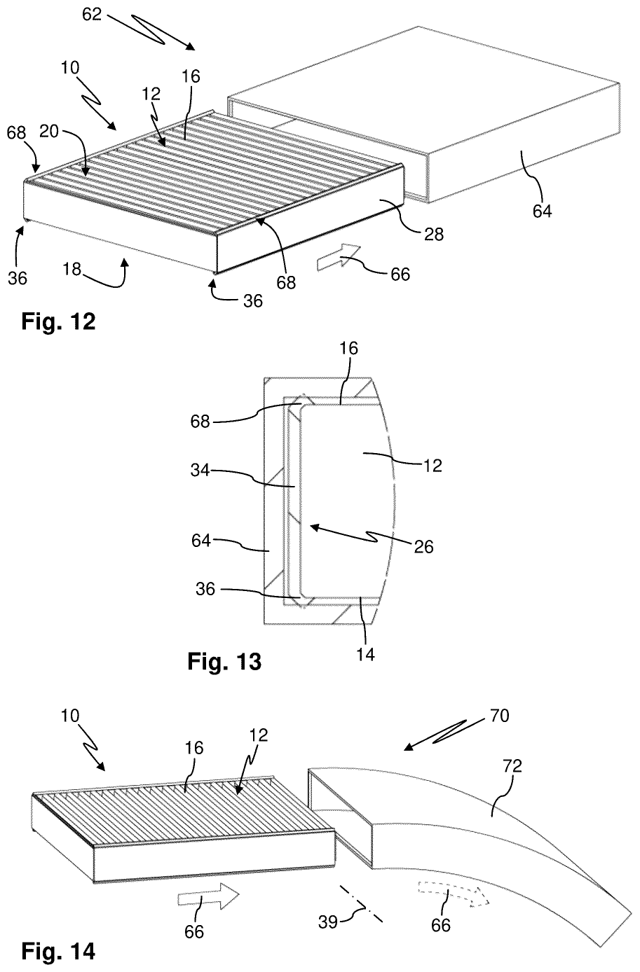

FIG. 12 shows an air filter 62 comprising a cuboid housing 64, a cover of which is not depicted. Likewise an inlet and an outlet are not depicted in detail. The housing 64 is designed for insertion of a flat filter element 10 in a direction 66 perpendicular to its upstream and downstream face 18, 20.

In the embodiment of FIG. 12, the filter element 10 does not only comprise first end sections 36, which are angled towards the filter medium 12, as described above for the filter element 10 depicted in FIG. 1. Here, the side elements 26, 28 do also protrude beyond the second fold edges 16 at the downstream face 20, see also FIG. 13. Second end sections 68 of the side elements 26, 28 are bent inwards to cover the second fold edges 16 adjacent to the first or second side face 30, 32, respectively. The second end sections 68 are designed in the same way as the first end sections 36. In particular, the second end sections 68 are adhered to the second fold edges 16.

Both, the first and second end sections 36, 68 of the first and second side elements 26, 28 sealingly abut housing 64, see FIG. 13. During installation, contact of adhesive, which is applied between filter medium 12 and side elements 26, 28, and the housing 64 is avoided, since the end sections 36, 68 cover the outer portions of fold edges 14, 16.

FIG. 14 shows an air filter 70 similar to the air filter 62 of FIG. 12; in particular the same filter element 10 is used in FIGS. 12 and 14. Air filter 70 differs from air filter 62 in that its housing 72 is curved along insertion direction 66. Consequently, the filter element 10 is bent during installation and remains bent or flat, depending on the remaining configuration of housing 72 n the completely installed state (not depicted in detail). Here, a bending axis 39 is parallel to the fold edges 14, 16 of filter medium 12. Sealing contact between filter element 10 and housing 72 is established as depicted in FIG. 13 and described above.

In summary, the invention refers to a deformable filter element comprising a flexible side element to seal pleats of its filter medium. An end section of the side element is bent over fold edges. The end section and the fold edges are secured to one another. The end section and a main section of the side element, which main section is typically arranged perpendicular to the fold edges, are neither parallel nor perpendicular to each other.

### LIST OF REFERENCE SIGNS

Filter element 10
Filter medium 12
First fold edges 14
Second fold edges 16
First edge 17
Upstream face 18
Second edge 19
Downstream face 20
Filter paper 22
Filling material 24
First side element 26
Second side element 28
First side face 30
Second side face 32
Main section 34
Angle 35
First end section 36
Angle 37
End face 38
Axis 39
Air filter 40; 52; 62; 70
Housing 42; 54; 64; 72
Housing parts 44, 46; 56, 58
Protrusion 48
Outer edge 50
Inner surface 51
Sealing surface 60
Insertion direction 66
Second end section 68

1. Filter element comprising a pleated filter medium and at least a first flexible side element, in particular a first flexible sideband, which seals pleats of the filter medium at a first side face,
wherein at least a first end section of the first side element protrudes above first fold edges of the filter medium,
wherein the first end section is angled towards the filter medium with respect to a main section of the first side element by an angle of at least 5° and at most 85° and,
wherein the first end section is affixed to the first fold edges.

2. Filter element according to claim 1, wherein the angle between the first end section and the main section is at least 22°, preferably at least 35°, and/or at most 67°, preferably at most 55°.

3. Filter element according to claim 1, wherein the first side element is made from a nonwoven fabric.

4. Filter element according to claim 1, wherein the first side element is glued to the filter medium and the first end section of the first side element is at least partly glued to the first fold edges, in particular wherein a glue layer provided between an end face of the first side element and the first fold edges has a thickness that is larger than the glue layer provided between a first edge of the first fold edges and an intersection of the main section and the first end section.

5. Filter element according to claim 1, wherein the filter medium comprises at least two layers of filter media and filling material, in particular particulate filling material, arranged between the layers.

6. Filter element according to claim 5, wherein the filling material comprises adsorbent material, in particular activated carbon, ion exchange resin and combinations thereof.

7. Filter element according to claim 1, wherein an end face of the first side element extends approximately perpendicular, preferably at an angle of 90°+/−30°, particularly preferably at an angle of 90°+/−15°, with respect to the first end section.

8. Filter element according to claim 1, further comprising a second flexible side element, in particular a second flexible sideband, which seals pleats of the filter medium at a second side face,
wherein at least a first end section of the second side element protrudes above the first fold edges of the filter medium,
wherein the first end section of the second side element is angled towards the filter medium with respect to a main section of the second side element by an angle of at least 5° and at most 85°,
and wherein the first end section of the second side element is affixed to the first fold edges.

9. Filter element according to claim 1, wherein a second end section of the first side element, or of the second side element if present, protrudes above second fold edges of the filter medium,
wherein the second end section is angled towards the filter medium with respect to a main section of the first side element by an angle of at least 5° and at most 85°,
and wherein the second end section is affixed to the second fold edges.

10. Filter element according to claim 1, wherein, in an undeformed state, the filter element is plate-shaped.

11. Filter element according to claim 1, wherein the filter medium annularly surrounds a longitudinal axis.

12. Air filter comprising a housing and a filter element according to claim 1.

13. Air filter according to claim 12, wherein the filter element is installed in the housing in an undeformed state.

14. Air filter according to claim 12, wherein the filter element is installed in the housing in a deformed state, in particular wherein the filter element is bent around an axis parallel to its fold edges and/or twisted around an axis perpendicular to its fold edges.

15. Air filter according to one of claim 12, wherein an outer edge of the filter element, which is formed between the first end section and an end face of the first side element, sealingly abuts the housing.
